(19) United States
(12) Patent Application Publication
(10) Pub. No.: US 2014/0152676 A1
(43) Pub. Date: Jun. 5, 2014

(54) LOW LATENCY IMAGE DISPLAY ON MULTI-DISPLAY DEVICE

(71) Applicants: Dave Rohn, Fort Collins, CO (US); Rod G. Fleck, Bellevue, WA (US); Cynthia Sue Bell, Kirkland, WA (US); Kevin Woo, Bellevue, WA (US); Jeff Maybee, Woodinville, WA (US); Timothy Osborne, Woodinville, WA (US)

(72) Inventors: Dave Rohn, Fort Collins, CO (US); Rod G. Fleck, Bellevue, WA (US); Cynthia Sue Bell, Kirkland, WA (US); Kevin Woo, Bellevue, WA (US); Jeff Maybee, Woodinville, WA (US); Timothy Osborne, Woodinville, WA (US)

(21) Appl. No.: 13/691,255

(22) Filed: Nov. 30, 2012

(51) Int. Cl. G09G 5/00

(52) U.S. Cl. CPC G09G 5/003
USPC 345/520; 345/1.3

(57) ABSTRACT

Embodiments are disclosed that relate to displaying images on multi-display devices with low latency. For example, one disclosed embodiment provides, on a display device comprising a first display and a second display, a method comprising receiving, processing a first image, and displaying the first image via the first display and not displaying the first image via the second display. The method further comprises receiving a second image, processing the second image while displaying the first image, and displaying the second image via the second display and not displaying the second image via the first display.

### BACKGROUND

A display device, such as a head-mounted display (HMD) device, may be configured to provide augmented reality experiences by displaying virtual images over a real-world background viewable through the display. As a user of a see-through display device changes location and/or orientation in a use environment, the device may be configured to detect the movements of the user, and to update displayed images accordingly.

### SUMMARY

Embodiments are disclosed that relate to displaying images on multi-display devices with low latency. For example, one disclosed embodiment provides, on a display device comprising a first display and a second display, a method comprising receiving, processing a first image, and displaying the first image via the first display and not displaying the first image via the second display. The method further comprises receiving a second image, processing the second image while displaying the first image, and displaying the second image via the second display and not displaying the second image via the first display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B show an embodiment of a see-through display device configured to display images via a plurality of displays, and also shows an example of an image displayed by the see-through display device.

FIG. 2 shows a schematic depiction of a flow of image data between a content producer and a content consumer.

FIG. 3 shows a flow diagram depicting an embodiment of a method for displaying low latency images via a plurality of displays.

FIG. 4 shows a timing diagram illustrating an embodiment of a method of displaying low latency images via a plurality of displays.

FIG. 5 shows a block diagram of an embodiment of a display device comprising a plurality of displays.

FIG. 6 shows a block diagram of an embodiment of a computing system.

### DETAILED DESCRIPTION

As mentioned above, as a user of a see-through display device moves within a use environment, the device may update displayed images in response to the movements. For example, some images may be configured to be stationary with respect to the real-world background (“world-locked images”). As a user moves relative to a world-locked image, the image may be re-rendered at different locations on the display in different orientations, with different light texturing, at different sizes, etc., as the view of the real world changes behind the display.

A see-through display device may update displayed images in response to sensor input received from motion sensors on the see-through display device. For example, as described in more detail below, a see-through display device may comprise outward-facing image sensors that acquire image data of the background environment viewable through the display, and/or inertial motion sensors that detect movement. Movements of the user may be detected from data acquired by such sensors, and the detected movements may be used to update the displayed image.

Some see-through display devices, such as some head-mounted display devices, may utilize separate left-eye and right-eye displays to display left-eye and right-eye images, for example, to enable display of stereoscopic images. Thus, in such devices, the left-eye and right-eye images may both be updated in response to user movements.

As a user moves, a rate at which a displayed image is updated compared a rate at which the user's view of the background scene changes (e.g. a rate at which the user turns his or her head) may impact a user experience. For example, with a world-locked image, if the re-rendering of the image has an undesirable amount of latency (i.e. lags the movements of the user to too large an extent), the user may perceive the image as being “jittery” as it is repositioned on the display in response to motion. Further, in cases where a world-locked or display-locked image is contextual to and displayed in proximity to (e.g. as an overlay over) a real world object, the contextual linking of the object and image may be lessened by latency.

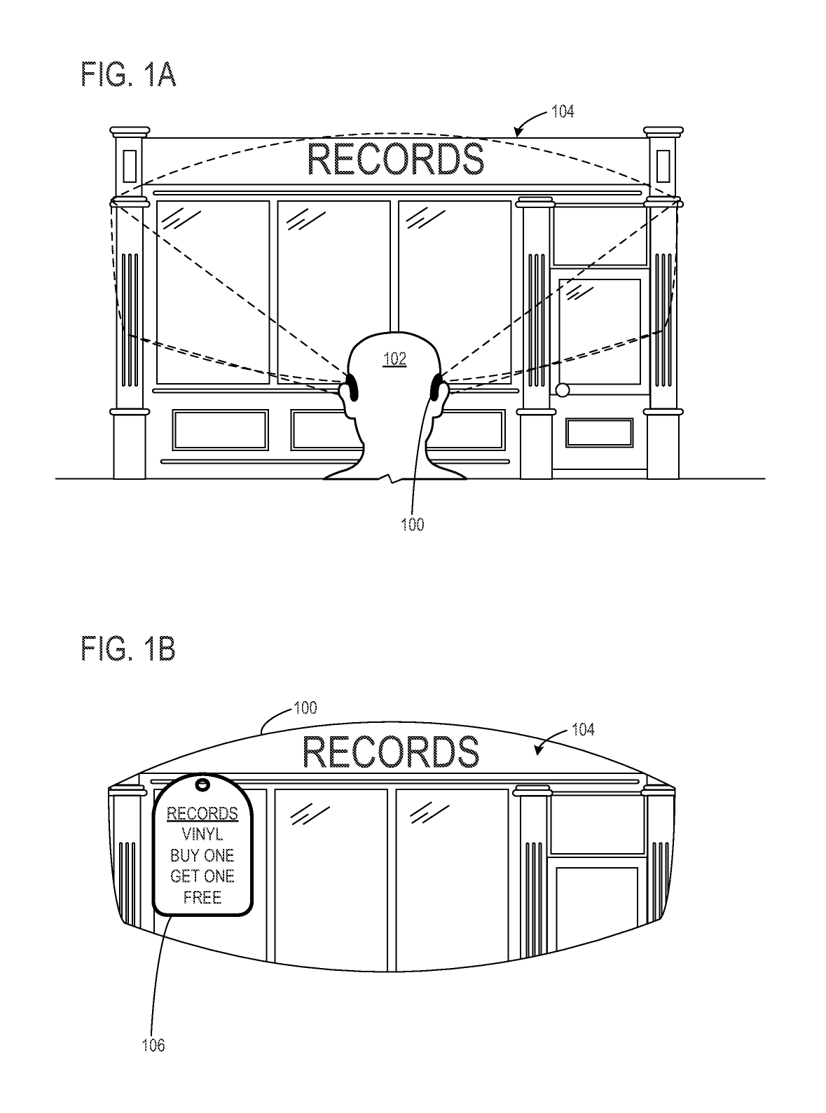

FIGS. 1A-1B shows an example of a world-locked image as viewed by a user 102 of a HMD device 100. As the user 102 gazes at a real-world background object 104 in the form of a record store, a store-specific virtual object 106 in the form of a promotional advertisement is displayed in front of the store. As the virtual object 106 is contextually linked to the real-world background object 104, the virtual object 106 is positionally locked to the real-world background object 104 so that the ad remains in front of the store from the user's perspective as the user moves about in the physical environment.

To maintain the world-locked view of the virtual object 106, the HMD device 100 may be configured to detect a relative location of the real-world background object 104 with respect to the user, and to update the display of the virtual object 106 so that it appears to be stationary with respect to the real object. However, if there is an undesirable amount of latency between production and display of the updated image, the virtual object 106 may jitter and/or move as the user moves, and therefore may appear not to be firmly locked to the real-world background object 101.

To avoid such latency issues, a see-through display device may be configured to update the images at a sufficiently fast rate. Latency between image production and image display is dependent upon factors such as the number of processes and computations per process performed to prepare and display the images, and also the computational resources available to perform such processing.

For a multi-display device, such as a HMD device with separate left-eye and right-eye displays, one possible method of decreasing a time between the generation and display of an updated positionally-sensitive image may be to incorporate sufficient computing resources into the device to update simultaneously-displayed right-eye and left-eye images with an acceptable amount of lag. However, the cost and power consumption characteristics of a display device may scale with the amount of computing resources provided on the device.

Therefore, embodiments are disclosed herein that relate to efficiently updating images on a multi-display display device in which low latency is desired. Briefly, the disclosed embodiments separately render left-eye and right-eye images in a time-sequential manner, and then display the left-eye and right-eye images at a sufficiently fast refresh rate to avoid undesirable flicker in the images. The time-sequential display of left-eye and right-eye images, as opposed to the simultaneous display of such images, may allow the number of calculations to be performed in each processing step to be reduced by approximately half. This may allow an image to be initially displayed to one of a user's eyes in approximately half the time it would take if the images were displayed simultaneously to both eyes. Therefore, this may allow the reduction of latency without increasing the computational resources of the system. While described herein in the context of a HMD device, it will be understood that the disclosed embodiments may be used with any other suitable multi-display system in which low latency is desired, including displays offset in a Z-direction (e.g. by distance as viewed by a user, such that one display is viewable behind and through another see-through display).

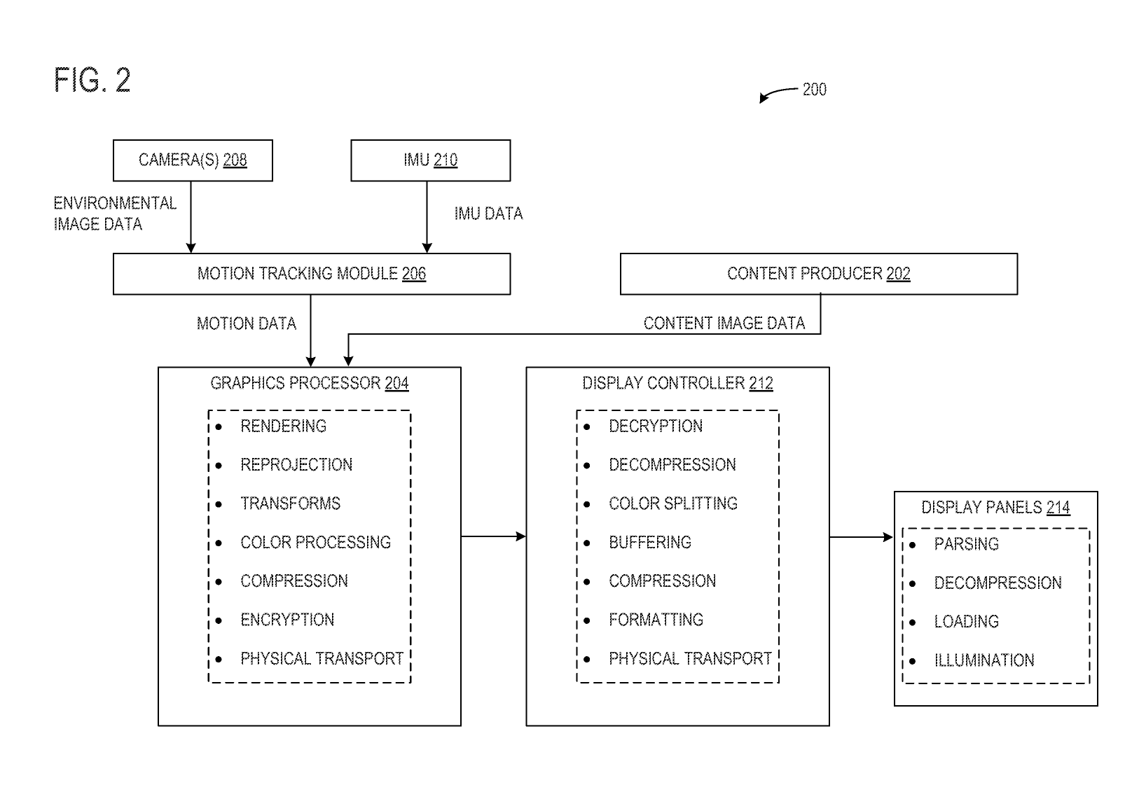

As mentioned above, latency is a function of a number of processing steps used to update an image in response to detected motion. The number of processing steps may be significant for some devices. As such, reducing an amount of time used by each processing step may provide significant reductions in latency. FIG. 2 illustrates an example embodiment of an image processing pipeline 200 for the HMD device of FIGS. 1A-B, and illustrates an example of a number of processing steps that may be performed before displaying an image. The image processing pipeline 200 begins at a content producer 202, such as an application that produces a virtual image for display. The content producer 202 may reside on the HMD device, or may reside remotely, for example, on another device in communication with the HMD device, such as a mobile phone, tablet computer, laptop computer, network-accessible server, or other suitable computing system. Where the content producer resides remotely, latency may pose a larger concern due to additional lag introduced by the network connection.

The content producer 202 provides content image data to a graphics processor 204, which also receives motion data from a motion tracking module 206. The motion tracking module 206 may determine motion data from any suitable inputs, including but not limited to environmental image data received from one or more cameras 208 (e.g. depth cameras and/or two-dimensional image cameras) and/or inertial motion data from an inertial motion detector unit (IMU) 210. Motion data is used by the graphics processor 204 to determine how to present images from the content producer 202.

Processed images from the graphics processor are provided to a display controller 212, and then to one or more image producing elements, illustrated as display panels 214. As mentioned above, the see-through display system comprises separate left-eye and right-eye displays. Thus, the see-through display system may comprise separate image producing elements for the left-eye and right-eye displays. Any suitable number of image producing elements may be used. For example, in some embodiments, each of the left-eye and right-eye displays may be configured to display color-sequential images. In such embodiments, each display may comprise a single image producing element and a light source for each image color. In other embodiments, each display may be configured to display RGB images (i.e. display all colors together, rather than in time sequence). In such embodiments, each display may comprise a separate image producing element for each color.

Any suitable image producing elements may be used. Examples include, but are not limited to, LCOS (liquid crystal on silicon) micro display panels, and/or other suitable display panels. In the discussion herein, the term “image” may be used to describe image data at any step in the described processing pipeline, as well as an end image displayed by the device.

As shown in FIG. 2, images from the content producer undergo multiple processing steps at each hardware location before being displayed. For example, at the graphics processor 204, the images may undergo rendering, reprojection (e.g. corrections to predictive processes based upon observed motion), various transforms, color processing, compression, encryption, and processes related to transport and physical layer network communications, among other possible processes. Likewise, at the display controller 212, the images may undergo decryption, decompression, color splitting (e.g. separating red, green, and blue data), buffering, compression, formatting, and physical/transport layer communications processing. Once the images reach the display panel, the images undergo decompression, loading (e.g. digital-to-analog conversion, writing to pixel array), and then illumination.

As mentioned above, the computational resources utilized by each of these processes is a function of the amount of data being processed. Thus, the time-sequential display of left-eye and right-eye image may allow each of these steps to be performed on only one half of a full two-display data set per image. This may allow the computations for a single image to be performed much more quickly than would be possible for two simultaneously-displayed images. Such time savings, in turn, may help to reduce perceived latency between user motions and a reaction of a displayed image to the motion.

As a more specific example, a multi-display HMD device may be configured to update simultaneously-displayed left-eye and right-eye images at a rate of 60 Hz or greater so that flicker is not perceived by a user. Adapted to display time-sequential left-eye and right-eye images, the device may display left and right eye images such that each eye sees a time-sequenced image at the 60 Hz rate, but offset by one half-of a 60 Hz cycle, such that one image is displayed beginning at a start of the 60 Hz cycle while the other image is displayed beginning at a later time in the 60 Hz cycle. If operated in this manner, the first updated image may displayed to the user in one half the time (e.g. ½ way through the first 60 Hz cycle) it would take to display the left-eye and right-eye images simultaneously. This may help to reduce the risk of undesirable amounts of latency without adding additional computing resources (e.g. on-chip memory) that could increase expense and/or power consumption. It will be noted that the latency associated with such a display device may be on the border of that which is human-perceptible. Thus, even small reductions in latency may provide a relatively large benefit for a user experience.

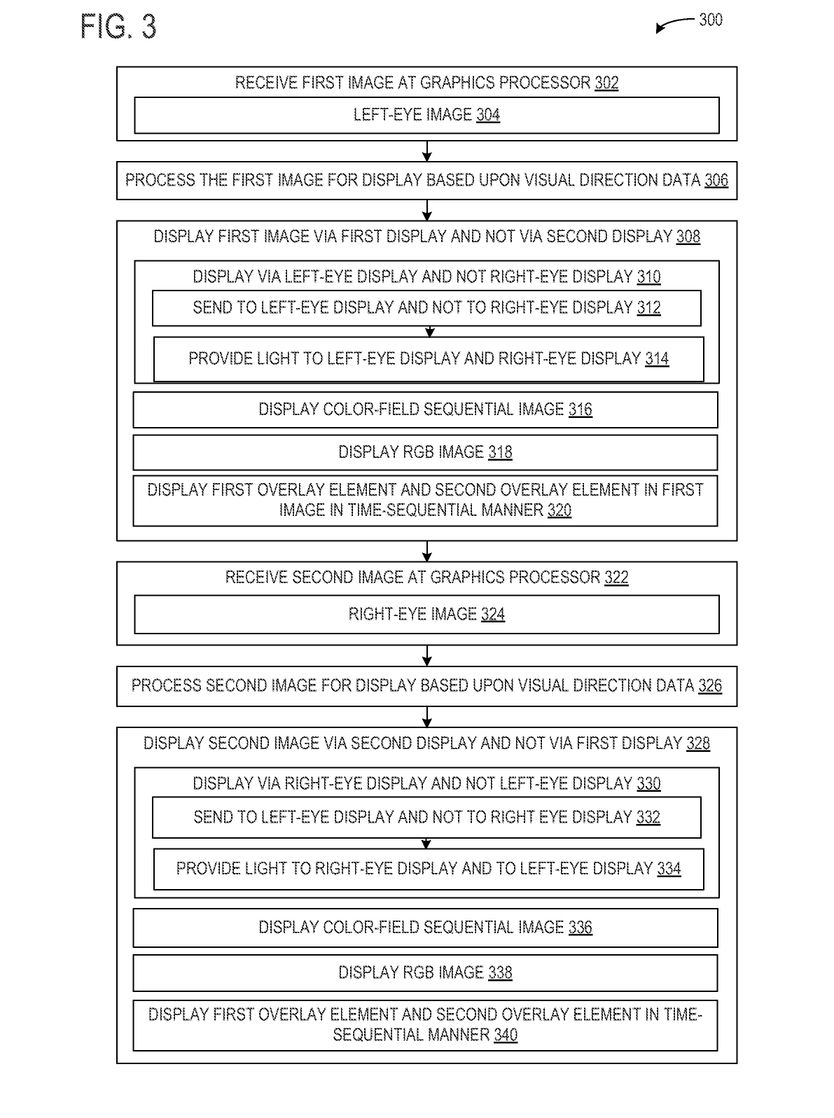

FIG. 3 shows a flow diagram depicting an embodiment of a method 300 for display low latency images on a multi-display device. Method 300 comprises, at 302, receiving a first image at a graphics processor or other suitable processing device, wherein the first image is for a first display of the multi-display device. For example, in some embodiments, the first image may comprise a left-eye image for a HMD device, as indicated at 304. Method 300 next comprises, at 306, rendering and processing the first image for display. In some embodiments, this may comprise processing the first image based upon visual direction data (e.g. motion data and/or image data) determined via input from one or more image sensors and/or motion sensors. It will be understood that such processing may comprise many individual processing steps performed at multiple different hardware locations.

After rendering and processing the first image, method 300 comprises, at 308, displaying the first image via the first display and not via the second display. As mentioned above, in a HMD, this may comprise displaying the left-eye image via a left-eye display and not via a right-eye display, as indicated at 310. In other embodiments, the first image may be displayed by any other suitable type of display.

The left-eye image may be displayed via the left-eye display in any suitable manner. For example, in some embodiments, the image may be sent to the left-eye display and not the right-eye display, as indicated at 312, and light may be provided to both displays, as indicated at 314. In other embodiments, the left-eye image may be sent to the left-eye and right-eye displays, and light may be provided to the left-eye display and not to the right-eye display.

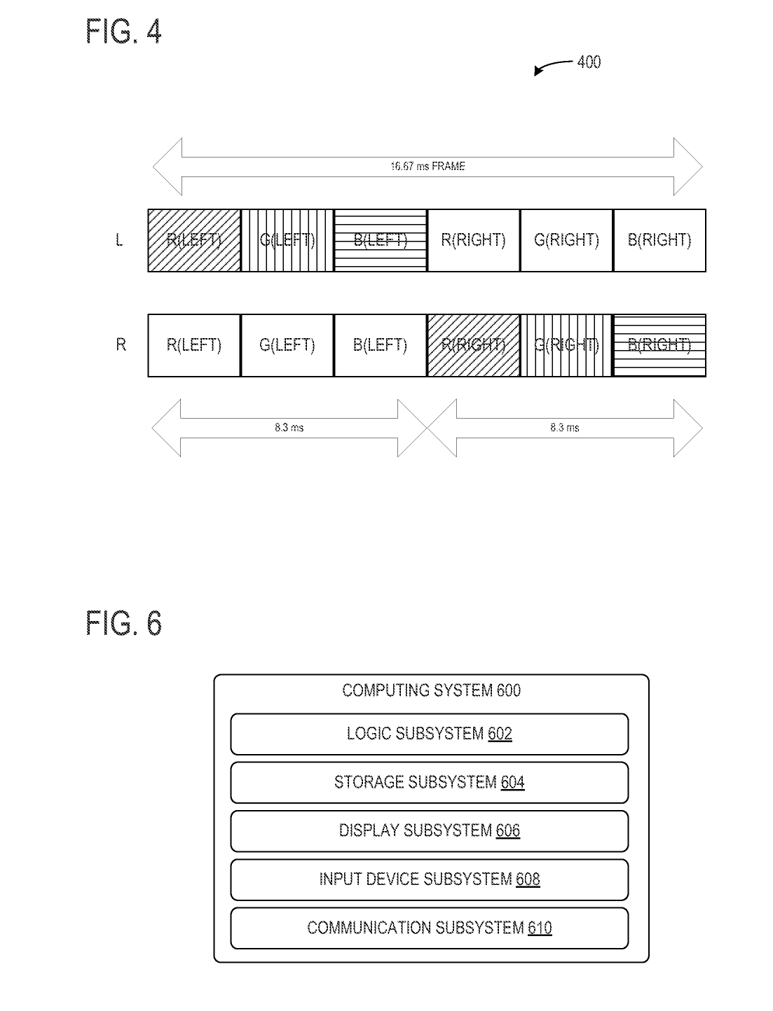

In some embodiments, the first image may be displayed as a color field-sequential image, as indicated at 316, such that separate red, green, and blue color field images are displayed in sequence for the image. An example of color field-sequential, time-sequential display of left-eye and right-eye images is described in more detail below with reference to FIG. 4. In yet other embodiments, the first image may be displayed as an RGB image, as indicated at 318, such that red, green, and blue color fields of the left eye image are displayed together.

Further, in some instances, such as where a scene has multiple separate overlay elements, a first overlay element may be processed and displayed before a second overlay element in a time sequential manner, as indicated at 320. This may help to further reduce apparent lag, as at least a portion of the first image may reach the display more quickly than if the entire first image were rendered and displayed together.

Continuing, method 300 next comprises performing similar processes for a second image, such as a right-eye image, such that the second image is processed while the first image is being displayed, and then displayed on a second display after the first image is displayed via the first display. Thus, method 300 comprises, at 322, receiving a second image at a graphics processor or other suitable processing device, and at 326, processing the second image for display. As mentioned above for the first image, such processing may be performed based upon visual direction data (e.g. motion data and/or image data) determined via input from one or more image sensors and/or motion sensors.

Method 300 further comprises, at 328, displaying the second image via the second display and not via the first display. In a HMD device, this may involve, at 330, displaying the image via a right-eye display and not a left-eye display. The right-eye image may be displayed via the right-eye display in any suitable manner. For example, in some embodiments, the right-eye image may be sent to the left-eye display and not to the right-eye display, as indicated at 332, and light may be provided to the left-eye display and to the right-eye display, as indicated at 334. In other embodiments, the right-eye image may be sent to the right-eye display and to the left-eye display, while light is provided to the right-eye display but not the left-eye display.

As described above for the first image, the second image may be displayed as a color field-sequential image, as indicated at 336, such that separate red, green, and blue images are displayed in sequence for the second image. In other embodiments, the second image may be displayed as an RGB image, as indicated at 338, such that red, green, and blue components of the left eye image are displayed together Likewise, as described above, the second image may be displayed such that a first overlay element and a second overlay element of the first image are displayed in a time-sequential manner. In this manner, augmented reality images aligned with a determined present visual direction for a user may be displayed with low latency.

FIG. 4 shows a timing diagram 400 illustrating an example embodiment of a method for displaying left-eye and right-eye images in a time-sequential, color field-sequential manner. A timing diagram for a left-eye image producing element is shown by the “L” time bar in FIG. 4, and a timing diagram for a right-eye image producing element is shown by the “R” time bar. Cross-hatching of each bar represents an update image loaded into the image producing element at that time (e.g. to update a previously-displayed image), and the text represents the illumination applied at that time. For example, the cross-hatching in the R(LEFT) block indicates that red color image for the left-eye image is loaded in the display panel and illuminated with red light. The absence of cross-hatching indicates where a previously-loaded image remains written to the panel, or where the panel is not otherwise updated.

In the embodiment of FIG. 4, red, green, and blue color field images of a new left-eye images are sequentially loaded into the left-eye image producing element to update a previously-displayed image. These color field images are illuminated sequentially with red, green, and blue light, such that each color field is displayed for ⅙ of a 16.67 ms frame. During this time, previously-loaded red, green and blue fields are sequentially displayed for a right-eye image, as represented by the absence of cross-hatching in those blocks.

Next, for the second half of the 16.67 ms frame, the right-eye image is similarly displayed in a color-sequential manner by sending red, green, and blue color fields of a right-eye image sequentially to the right-eye image producing element, and illuminating the right-eye image producing element and left-eye image producing element with the appropriate color light sequence, such that the new right-eye image and previously-loaded left-eye images are displayed. It will be understood that the timing diagram of FIG. 4 is presented for the purpose of example, and is not intended to be limiting in any manner.

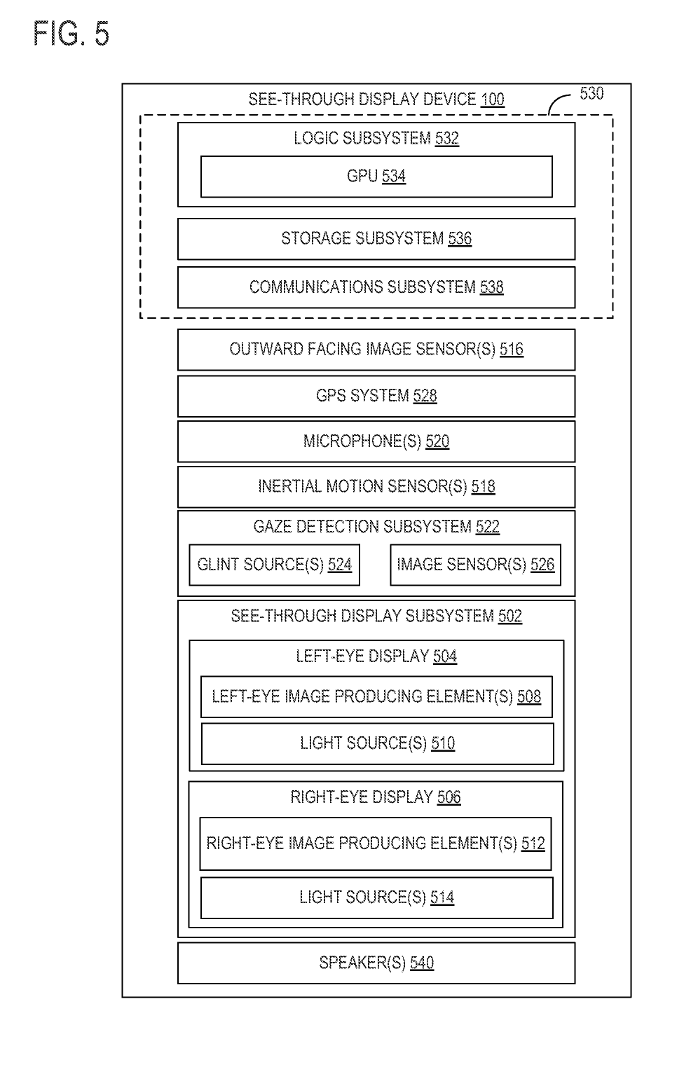

As mentioned above, the methods described above may be performed via any suitable see-through display device, including but not limited to head-mounted see-through display device 100 of FIG. 1. FIG. 5 shows a block diagram of an example configuration of see-through display device 100.

See-through display device 100 comprises a see-through display system 502 having a left-eye display 504 and a right-eye display 506. The left-eye display 504 comprises one or more left-eye image producing elements 508. For example, where the left-eye display 504 is configured to display time-sequential, color-sequential images, the left-eye display 504 may comprise a single image producing element, e.g. a single LCOS panel or other microdisplay panel. Likewise, where the left-eye display 504 is configured to display RGB images, the left-eye display may comprise a microdisplay for each color. Further, the left-eye display 504 also may comprise one or more light sources 510 configured to illuminate the image producing element(s) 508 if the image producing element(s) are not emissive. The right-eye display 506 also comprises one or more right-eye image producing elements 512, and may comprise one or more light sources 514.

The see-through display device 100 also may comprise one or more outward facing image sensors 516 configured to acquire images of a background scene being viewed by a user. Images from the image sensor may be used to detect user movements, and also may be used to detect objects in the background scene of the see-through display device 100. Outward facing image sensors 516 may include one or more depth sensors (including but not limited to stereo depth imaging arrangements) and/or one or more two-dimensional image sensors. Motion also may be detected via one or more inertial motion sensors one or more inertial motion sensors 518, as described above. The see-through display device 100 also may include one or more microphones 520 configured to detect sounds, such as voice commands from a user.

Continuing, the see-through display device 100 may further comprise a gaze detection subsystem 522 configured to detect a direction of gaze of each eye of a user. The gaze detection subsystem 522 may be configured to determine gaze directions of a user's eyes in any suitable manner. For example, in the depicted embodiment, the gaze detection subsystem 522 comprises one or more glint sources 524, such as infrared light sources, configured to cause a glint of infrared light (“Purkinje images”) to reflect from the cornea of each eye of a user, and one or more inward-facing image sensors 526 configured to capture an image of one or more eyes of the user. Images of the glints and of the pupils as determined from image data gathered via image sensor(s) 526 may be used to determine an optical axis of each eye. It will be understood that the gaze detection subsystem 522 may have any suitable number and arrangement of light sources and image sensors.

The see-through display device 100 may further comprise additional sensors. For example, see-through display device 100 may comprise a global positioning (GPS) subsystem 528 to allow a location of see-through display device 100 to be determined.

The see-through display device 100 further comprises a computing device 530 having a logic subsystem 532, a storage subsystem 536, and a communication subsystem 538 The logic subsystem 532 may comprise a graphics processing unit 534 configured to process images for display by the left-eye display 504 and the right-eye display 506 in a time-sequential manner, as described above. The storage subsystem 536 may comprises instructions stored thereon that are executable by logic subsystem 532 to control the display of images by the left-eye display 504 and the right-eye display 506, among other tasks. The communication subsystem 538 may be configured to communicate with other computing devices by wired and/or wireless links. For example, the communication subsystem 538 may allow the see-through display device to obtain image data from a content producer located remotely from the see-through display device, as mentioned above. Further information regarding example hardware for the logic subsystem 532, storage subsystem 536, communication subsystem 538, and other above-mentioned components is described below with reference to FIG. 6.

It will be appreciated that the depicted see-through display device 100 is provided by way of example, and thus is not meant to be limiting. Therefore it is to be understood that the head-mounted device may include additional and/or alternative sensors, cameras, microphones, input devices, output devices, etc. than those shown without departing from the scope of this disclosure. The physical configuration of a head-mounted display device and its various sensors and subcomponents may take a variety of different forms without departing from the scope of this disclosure.

Further, it will be understood that a computing system configured to display low-latency images via multiple displays may take any suitable form other than a head-mounted display device, and may include a mainframe computer, server computer, desktop computer, laptop computer, tablet computer, home-entertainment computer, network computing device, gaming device, mobile computing device, mobile communication device (e.g., smart phone), other wearable computer, etc. It will further be understood that the methods and processes described above may be implemented as a computer-application program or service, an application-programming interface (API), a library, and/or other computer-program product.

FIG. 6 schematically shows a non-limiting embodiment of a computing system 600 that can perform one or more of the methods and processes described above. Computing system 600 is shown in simplified form, and as mentioned above may represent any suitable device and/or combination of devices, including but not limited to the computing device 530 of HMD device 100.

Computing system 600 includes a logic subsystem 602 and a storage subsystem 604. Computing system 600 may optionally include a display subsystem 606, input device subsystem 608, communication subsystem 610, and/or other components not shown in FIG. 6. Computing system 600 may also optionally include or interface with one or more user input devices, such as a keyboard, mouse, game controller, camera (depth and/or two-dimensional), microphone, and/or touch screen, for example. Such user-input devices may form part of input device subsystem 608 or may interface with input device subsystem 608.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

Logic subsystem 602 may include one or more processors configured to execute software instructions. Additionally or alternatively, logic subsystem 602 may include one or more hardware or firmware logic machines configured to execute hardware or firmware instructions. The processors of logic subsystem 602 may be single-core or multi-core, and the programs executed thereon may be configured for sequential, parallel or distributed processing. Logic subsystem 602 may optionally include individual components that are distributed among two or more devices, which can be remotely located and/or configured for coordinated processing. Aspects of the logic subsystem may be virtualized and executed by remotely accessible networked computing devices configured in a cloud-computing configuration.

Storage subsystem 604 includes one or more physical, non-transitory, devices configured to hold data and/or instructions executable by the logic subsystem to implement the herein-described methods and processes. When such methods and processes are implemented, the state of storage subsystem 604 may be transformed—e.g., to hold different data.

Storage subsystem 604 may include removable media and/or built-in devices. Storage subsystem 604 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices. In some embodiments, logic subsystem 602 and storage subsystem 604 may be integrated into one or more unitary devices, such as an application-specific integrated circuit (ASIC), or a system-on-a-chip.

It will be appreciated that storage subsystem 604 includes one or more physical, non-transitory devices. However, in some embodiments, aspects of the instructions described herein may be propagated in a transitory fashion by a pure signal (e.g., an electromagnetic signal, an optical signal, etc.) that is not held by a physical device for a finite duration. Furthermore, data and/or other forms of information pertaining to the present disclosure may be propagated by a pure signal.

The term “program” may be used to describe an aspect of computing system 600 implemented to perform a particular function. In some cases, a program may be instantiated via logic subsystem 602 executing instructions held by storage subsystem 604. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

Display subsystem 606 may be used to present a visual representation of data held by storage subsystem 604. As the herein described methods and processes change the data held by the storage subsystem, and thus transform the state of the storage subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or storage subsystem 604 in a shared enclosure, or such display devices may be peripheral display devices.

Communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a display device comprising a first display and a second display, a method of displaying images, the method comprising:
receiving a first image;
processing the first image;
displaying the first image via the first display and not displaying the first image via the second display;
receiving a second image;
processing the second image while displaying the first image; and
displaying the second image via the second display and not displaying the second image via the first display such that display of the second image is temporally offset from display of the first image.

2. The method of claim 1, wherein displaying the first image via the first display comprises displaying the first image in a color field-sequential manner, and displaying the second image via the second display comprises displaying the second image in a color field-sequential manner.

3. The method of claim 1, wherein displaying the first image via the first display comprises displaying the first image as an RBG image, and wherein displaying the second image via the second display comprises displaying the second image as an RGB image.

4. The method of claim 1, wherein displaying the first image via the first display and not displaying the first image via the second display comprises sending the image to a first image producing element and not to a second producing element while illuminating the first image producing element and the second image producing element.

5. The method of claim 1, wherein the display device comprises a head-mounted display, wherein the first image producing element is a left-eye image producing element, and wherein the second image producing element is a right-eye image producing element.

6. The method of claim 5, wherein the left eye image and the right eye image comprise overlay images for an augmented reality see-through display.

7. The method of claim 1, further comprising determining a visual direction via sensor data, and wherein processing the first image and processing the second image comprise rendering the first image and the second image based upon the visual direction determined.

8. The method of claim 1, wherein displaying the first image via the first display and not displaying the first image via the second display comprises providing the first image to a first image producing element and to a second image producing element, and providing light to the first image producing element while not providing light to the second image producing element.

9. The method of claim 1, wherein the first image is displayed beginning at a start of a 16 ms frame and the second image is displayed beginning at a later time within the 16 ms frame.

10. A see-through head-mounted display device, comprising;
a graphics processor;
a left-eye display comprising a left-eye image producing element;
a right-eye display comprising a right-eye image producing element; and
a storage subsystem comprising instructions stored thereon that are executable to:
process a left-eye image via the graphics processor;
display the left-eye image via the left-eye display and not display the left-eye image via the right-eye display;
while displaying the left-eye image, process a right-eye image via the graphics processor; and
display the right-eye image via the right-eye display and not display the right-eye image via the left-eye display such that display of the right-eye image is temporally offset from display of the left-eye image.

11. The device of claim 10, wherein the instructions are executable to display the left-eye image in a color field-sequential manner, and to display the right-eye image in a color field-sequential manner.

12. The device of claim 10, wherein the instructions are executable to display the left-eye image as an RBG image, and to display the right-eye image as an RGB image.

13. The device of claim 10, wherein the instructions are executable to display the left-eye image via the left-eye display and not via the right-eye display by sending the image to the left-eye image producing element and not to right-eye image producing element while illuminating the left-eye image producing element and the right-eye image producing element, and
wherein the instructions are executable to display the right-eye image via the right-eye display by sending the right-eye image to the right-eye image producing element and not to the left-eye image producing element while illuminating the left-eye image producing element and the right-eye image producing element.

14. The device of claim 10, wherein the left-eye image producing element and the right-eye image producing element comprise LCOS image producing elements.

15. The device of claim 10, wherein the instructions are executable to display the left-eye image via the left-eye display and not display the right-eye image via the right-eye display by providing the left-eye image to the left-eye image producing element and to the right-eye image producing element, and providing light to the left-eye image producing element while not providing light to the right-eye image producing element.

16. The device of claim 10, wherein the instructions are executable to display the first image beginning at a start of a 16.67 ms frame and the second image beginning at a later time in the 16.67 ms frame.

17. In a see-through head-mounted display device comprising a left-eye display having a left-eye image producing element and a right-eye display having a right-eye image producing element, a method of displaying images, the method comprising receiving at a graphics processor a left-eye image;
processing the left-eye image via the graphics processor;
sending the left-eye image to the left-eye image producing element image producing element while not sending the left-eye image to the right-eye image producing element;
providing light to the left-eye image producing element and to the right-eye image producing element;
receiving at the graphics processor a right-eye image;
while displaying the left-eye image via the left-eye image producing element, processing the right-eye image via the graphics processor;
sending the right-eye image to the right-eye image producing element while not sending the right-eye image to the left-eye image producing element; and
providing light to the right-eye image producing element and to the left-eye image producing element.

18. The method of claim 17, further comprising displaying the left-eye image in a color field-sequential manner, and displaying the right-eye image in a color field-sequential manner.

19. The method of claim 10, further comprising displaying the left-eye image and the right-eye image as RGB images.

20. The method of claim 17, wherein the left-eye image producing element and the right-eye image producing element comprise LCOS image producing elements.
